(19) United States
(12) Patent Application Publication
(10) Pub. No.: US 2021/0170924 A1
(43) Pub. Date: Jun. 10, 2021

(54) SYSTEM AND METHOD FOR REDUCING INJURY IN AUTONOMOUS VEHICLES

(71) Applicant: Continental Automotive Systems, Inc., Auburn Hills, MI (US)

(72) Inventors: Christopher James Palazzolo, Littleton, CO (US); Robert M. Andres, Clarkston, MI (US)

(73) Assignee: Continental Automotive Systems, Inc., Auburn Hills, MI (US)

(21) Appl. No.: 16/703,222

(22) Filed: Dec. 4, 2019

(51) Int. Cl. B60N 2/427

(52) U.S. Cl. CPC B60N 2/42727; B60N 2/4279

(57) ABSTRACT

An occupant safety system and method includes identifying a potential impact of a vehicle with an external object utilizing an environment sensor. A position of an occupant of the vehicle is sensed by one or more position sensors. An advantageous position of the occupant is determined based on the identified potential impact. The occupant is then repositioned to the advantageous position in response to the identified potential impact.

### TECHNICAL FIELD

The technical field relates generally to for a control system and method of reducing injury in autonomous vehicles.

### BACKGROUND

Typically, automotive vehicles include a plurality of seats, with each seat holding an occupant upright and facing in a standard forward direction of travel. However, such automotive vehicles may utilize flexible seating configurations. For example, seats may recline to allow an occupant to rest in a lying position. In another example, seats may swivel or rotate to allow multiple occupants to face one another. Various other seating configurations are known or can be anticipated. It is likely that the availability and use of flexible seating configurations will increase with the rise in autonomous and semi-autonomous vehicle technology.

One drawback to flexible seating configurations in automobiles regards the deployment of safety devices (e.g., air bags and seatbelts) to protect the occupants in a crash. For instance, air bags are typically designed for circumstances where the occupant is facing forward in the vehicle and sitting in an upright position.

### BRIEF SUMMARY

In one exemplary embodiment, a method includes identifying a potential impact of a vehicle with an external object. The method further includes sensing a position of an occupant of the vehicle. The method also includes determining an advantageous position of the occupant based on the identified potential impact. The method further includes repositioning the occupant to the advantageous position in response to the identified potential impact.

In one exemplary embodiment, an occupant safety system for a vehicle is disclosed. The vehicle includes a seat for supporting an occupant of the vehicle and a mechanism operatively connected to the seat to change the position of the occupant between a first position and a second position. The occupant safety system includes an environment sensor configured to sense an environment around the vehicle. The system also includes a position sensor configured to sense the position of the occupant. The system further includes a processor in communication with the environment sensor, the position sensor, and the mechanism. The processor is configured to identify a potential impact of the vehicle with an external object utilizing the environment sensor. The processor is also configured to determine a position of the occupant utilizing the position sensor. The processor is further configured to determine an advantageous position of the occupant based on the identified potential impact. The processor is also configured to control the mechanism to reposition the occupant to the advantageous position in response to the identified potential impact.

In one exemplary embodiment, a vehicle includes a seat for supporting an occupant and a mechanism operatively connected to the seat to change the position of the occupant between a first position and a second position. The vehicle also includes an environment sensor configured to sense an environment around the vehicle. The vehicle further includes a position sensor configured to sense the position of the occupant. The vehicle also includes a processor in communication with the sensors and the mechanism. The processor is configured to identify a potential impact of the vehicle with an external object utilizing the environment sensor. The processor is also configured to determine a position of the occupant utilizing the position sensor. The processor is further configured to determine an advantageous position of the occupant based on the identified potential impact. The processor is also configured to control the mechanism to reposition the occupant to the advantageous position in response to the identified potential impact.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram of a vehicle having an occupant safety system according to one exemplary embodiment;

FIG. 2 is a side-view of an occupant in a seat of the vehicle in a generally horizontal position according to one exemplary embodiment;

FIG. 3 is a side-view of the occupant in the seat of the vehicle in a generally upright position according to one exemplary embodiment;

FIG. 4 is a top-view of seats of the vehicle each facing a center line of the vehicle according to one exemplary embodiment;

FIG. 5 is a top-view of seats of the vehicle each facing the front of the vehicle according to one exemplary embodiment;

FIG. 6 is a flowchart showing a method of reducing injury in autonomous vehicles according to one exemplary embodiment.

### DETAILED DESCRIPTION

Referring to the Figures, wherein like numerals indicate like parts throughout the several views, a vehicle 100 having an occupant safety system 102 is shown and described herein.

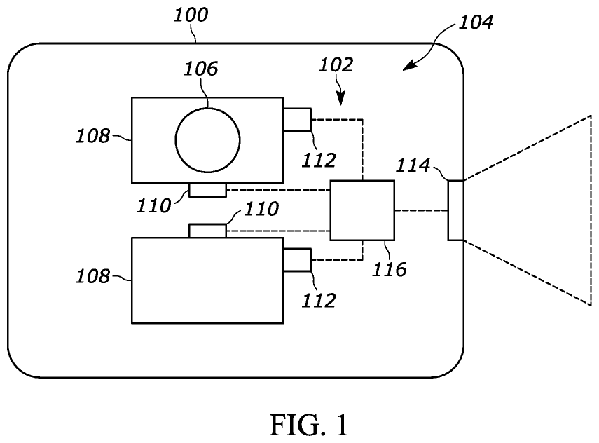

FIG. 1 shows the vehicle 100 having the occupant safety system 102. The vehicle in the exemplary embodiments is an automobile (not separately numbered) having a propulsion system (e.g., an engine and a powertrain) (not shown) as is widely recognized. Of course, other suitable vehicles 100, other than the automobile, may be implemented with the occupant safety system. The vehicle 100 of the exemplary embodiments includes an interior compartment 104 that may accommodate at least one occupant 106.

The vehicle 100 includes a seat 108 for supporting an occupant 106. The seat 108 is configurable to move between at least a first seat position and a second seat position. A mechanism 110 is operatively connected to the seat 108 to change the position of the seat 108. As such, the mechanism 110 is operable to change the position of the occupant 106 between at least a first occupant position (not numbered) and a second occupant position (not numbered). However, it should be appreciated that the seat 108, and thus the occupant 106, may be repositioned to any number of positions. Further, it should be appreciated that the vehicle 100 may include a plurality of seats 108 for supporting a plurality of occupants 106.

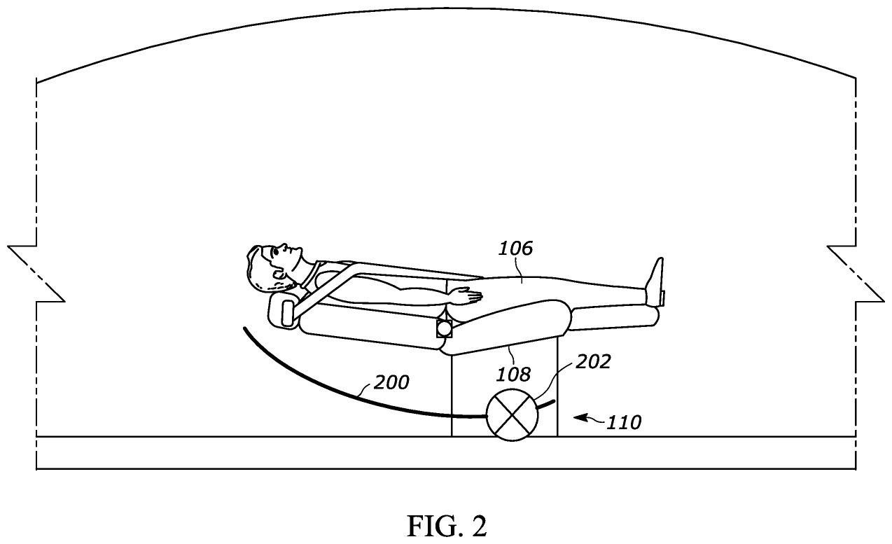

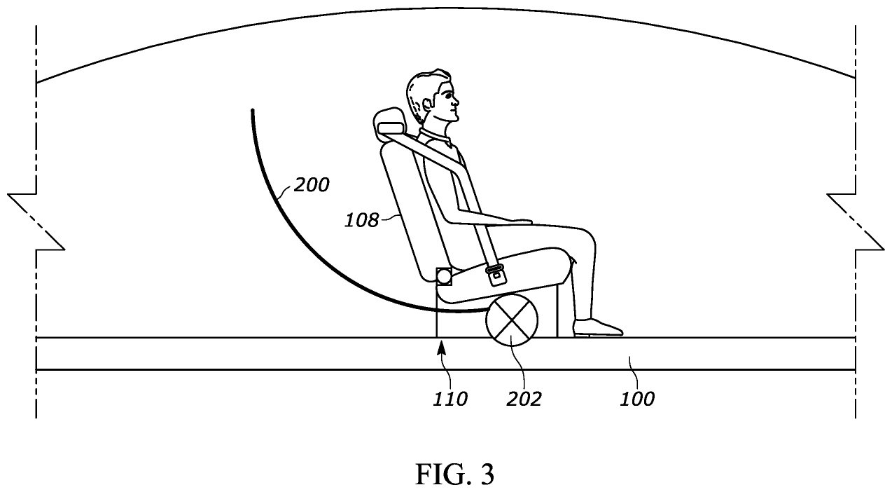

In one exemplary embodiment, as shown in FIGS. 2 and 3, the mechanism 110 for moving the seat 108 includes a drive rail 200 and a drive motor 202. The seat 108 is coupled with the drive rail 200, and the drive motor 202 is used to move the drive rail 200, which in turn moves the seat 108 between positions.

The seat 108 further optionally includes a mount (not shown), such as a rotatable mount that is coupled with the vehicle 100, such as the frame (not shown) of the vehicle 100 to provide stability to the seat 108.

The occupant safety system 102 includes a position sensor 112. The position sensor 112 is configured to sense the position of the seat 108 and/or the occupant 106. The position sensor 112 may be implemented with any suitable device for sensing the seat 108 and/or a portion of the seat 108. These position sensors 112 may include, but are certainly not limited to, magnetic field sensors, angular sensors, rotary and/or linear position sensors, etc. The position sensor 112 may also be implemented with a camera for sensing the position of the occupant 106 and/or the seat 108 as well as confirming the presence of an occupant 106 in the seat 108. Of course, other implementations of the position sensor 112 will be realized by those of ordinary skill in the art.

The occupant safety system 102 also includes an environment sensor 114. The environment sensor 114 is configured to sense an environment around the vehicle. In one exemplary embodiment, the environment sensor 114 produces data that may be utilized to determine a potential impact of the vehicle 100 with another object (not shown), including, but certainly not limited to, another vehicle. The environment sensor 114 may be implemented with a camera, radar, sonar, lidar, or other suitable device as is readily appreciated by those of ordinary skill in the art. In another embodiment, the environment sensor 114 may produce data indicating a current impact of the vehicle 100 with an object, e.g., an accelerometer.

The occupant safety system 102 further includes a processor 116. The processor 116 may be implemented as a computational device configured to perform calculations, send and/or receive data, and/or execute instructions (i.e., run a program). The processor 116 may be a microprocessor, microcontroller, application specific integrated circuit (“ASIC”), programmable logic controller, or any other suitable device as readily appreciated by those of ordinary skill in the art.

The occupant safety system 102 may include additional electrical and electronic circuitry devices, integrated circuits, and/or other devices (none shown) for interfacing the processor 116 with other systems and/or devices. For example, the occupant safety system 102 may include an analog-to-digital converter (“ADC”) (not shown), a digital-to-analog converter (“DAC”), a control relay, a power transistor, and a communications processor (not shown).

The processor 116 is in communication with the environment sensor 114 and receives data from the environment sensor 114 regarding a potential or current impact of the vehicle 100 with another object. The processor 116 is also in communication with the position sensor 112 and receives data from the position sensor 112 regarding the position of the seat 108 and/or the occupant 106.

The processor 116 may be configured to determine an advantageous position of the occupant 106 based on the identified potential impact. The advantageous position may be a single, pre-determined position. For example, the advantageous position may be a generally upright, forward-facing position. However, it should be appreciated that other advantageous positions may be realized, based on the structure of the vehicle, air bag positions, direction of the potential impact, location of the potential impact, and/or other variables. The determination of the advantageous position of the occupant 106 may be based on a look-up table using any sensing variable. Alternatively, the determination of the advantageous position may be performed by an algorithm, such as, but not limited to an artificial intelligence algorithm.

The processor 116 is also in communication with the mechanism 110 to change the position of the seat 108. The processor 116 is configured to selectively send a control signal to the mechanism 110 to control the position of the seat 108. As such, the processor 116 is configured to control the mechanism 110 to reposition the occupant 106 to the determined advantageous position in response to an identified potential impact.

In one exemplary embodiment, the position sensor is 112 senses that the occupant 106 is facing generally away from a potential impact. The processor 116 then controls the mechanism 110 to reposition the occupant 106 to generally face toward the potential impact. This repositioning works in concert with the airbags (not shown) of the vehicle 100, which are typically positioned to maximize protection for occupants 106 facing forward in the vehicle 100.

FIGS. 2 and 3 show one example of such an embodiment. In FIG. 2, the first position of the seat 108 is a generally horizontal position, allowing the occupant to be in a generally lying position. In FIG. 3, the second position of the seat 108 is a conventional seating position, putting the occupant 106 in a generally upright position. In this embodiment, in the event of a potential impact of the vehicle 100, the processor 116 automatically controls the mechanism 110 to reposition the occupant 106 to the generally upright position prior to the impact of the vehicle 100.

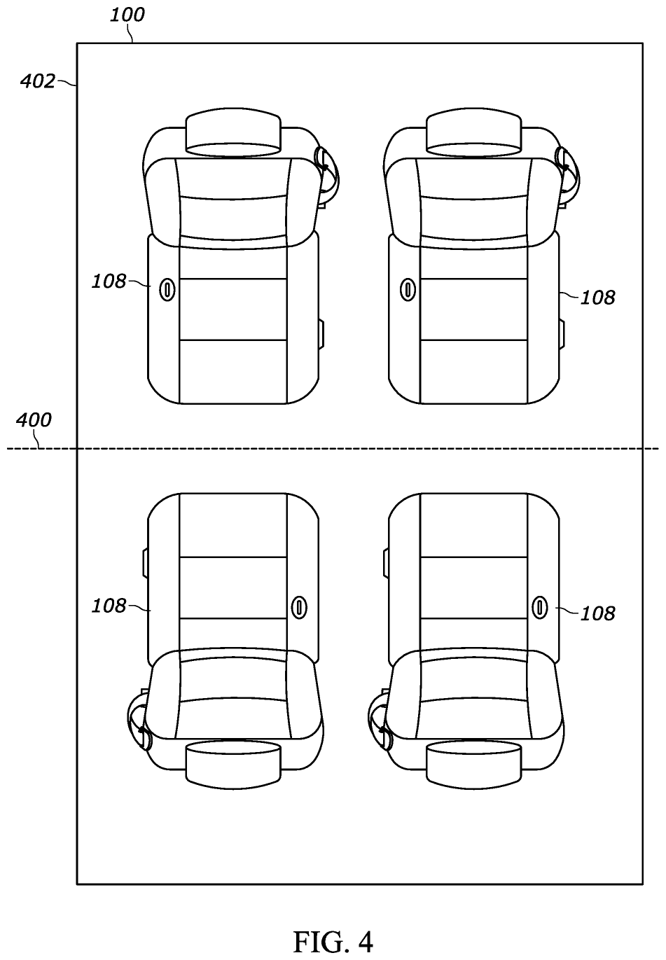

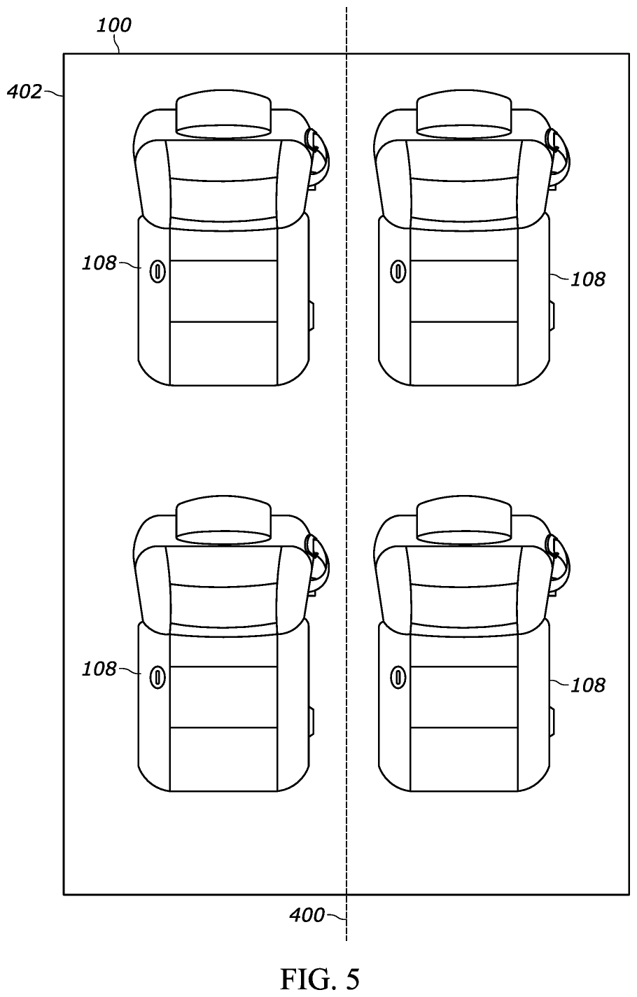

FIGS. 4 and 5 show another example of such an embodiment. In FIG. 4, the first position of the seat 108 is directed toward a center line 400 of the vehicle 100. As such, the occupant 106 may face other occupants 106 of the vehicle 100, instead of facing a front 402 of the vehicle 100. In FIG. 5, the second position of the seat 108 in this embodiment is directed toward the front 402 of the vehicle 100.

The processor 116 may be further configured to calculate a time to impact of the vehicle with the external object. This calculation is done in response to the potential impact of the vehicle with the external object being identified. The time to impact may be calculated utilizing data from the environment sensor 114 and/or other sensors (not shown). For example, the distance to the external object, the speed of the external object, the acceleration of the external object, the speed of the vehicle 100, and/or the acceleration of the vehicle 100 may be utilized to calculate this time.

The processor 116 may also be configured to calculate a time to reposition the occupant 106 from the sensed position to the more advantageous position, i.e., from the first position to the second position. This time may be based, at least in part, on the sensed position of the seat 108 and historical data regarding the speed of moving the seat using the mechanism 110.

In some cases, it may not be prudent to begin moving the occupant to the more advantageous position, particularly if the repositioning may not be complete prior to the impact. As such, in one embodiment, the processor 116 may further be configured to reposition the occupant from the first position to the second position only if the calculated time to reposition the occupant is less than the calculated time to impact. The processor 116 may also take into account the time necessary for a restraint device to fully activate. For example, the processor 116 may not move the occupant between positions if the time to move the occupant and the time is greater than the time to inflate an airbag to protect the occupant.

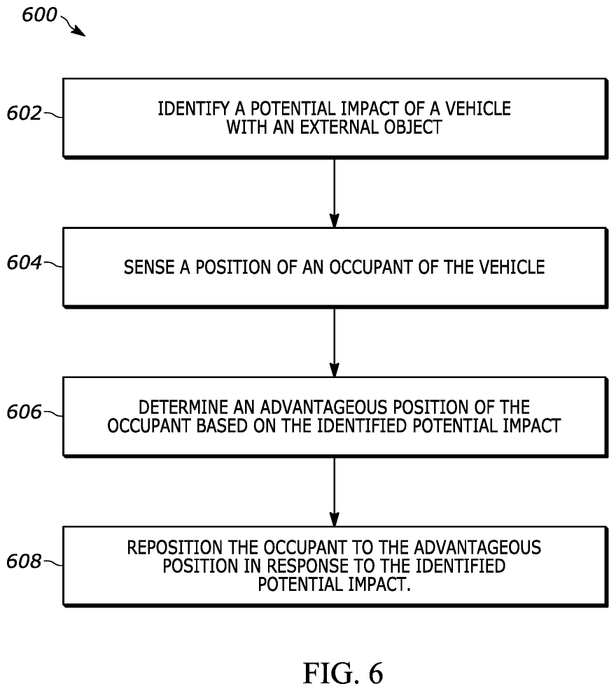

Referring now to FIG. 6, a method 600 of reducing injury in autonomous vehicles is presented. The method 600 includes, at 602, identifying a potential impact of a vehicle 100 with an external object. The method 600 also includes, at 604, sensing a position of an occupant of the vehicle. The method 600 further includes, at 606, determining an advantageous position of the occupant based on the identified potential impact. The method also includes, at 608, repositioning the occupant to the advantageous position in response to the identified potential impact.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

1. A method comprising:
identifying a potential impact of a vehicle with an external object;
sensing a position of an occupant of the vehicle;
determining an advantageous position of the occupant based on the identified potential impact; and
repositioning the occupant to the advantageous position in response to the identified potential impact.

2. The method as set forth in claim 1 wherein sensing the position of the occupant of the vehicle is further defined as sensing that the occupant is in a generally lying position and the advantageous position is a generally upright position.

3. The method as set forth in claim 1 wherein sensing the position of the occupant of the vehicle is further defined as sensing that the occupant is facing generally away from the potential impact and the advantageous position is facing generally toward the potential impact.

4. The method as set forth in claim 1 further comprising calculating a time to impact of the vehicle with an external object in response to the potential impact of the vehicle with the external object being identified.

5. The method as set forth in claim 4 further comprising calculating a time to reposition the occupant from the sensed position to the more advantageous position.

6. The method as set forth in claim 5 wherein repositioning the occupant is only performed if the calculated time to reposition the occupant is less than the calculated time to impact.

7. The method as set forth in claim 1 wherein repositioning the occupant is further defined as operating a drive motor.

8. A vehicle comprising:
a seat for supporting an occupant;
a mechanism operatively connected to said seat to change the position of the occupant between a first position and a second position;
an environment sensor configured to sense an environment around the vehicle;
a position sensor configured to sense the position of the occupant;
a processor in communication with said environment sensor, said position sensor, and said mechanism and configured to
identify a potential impact of the vehicle with an external object utilizing said environment sensor,
determine a position of the occupant utilizing said position sensor,
determine an advantageous position of the occupant based on the identified potential impact; and
control said mechanism to reposition the occupant to the advantageous position in response to the identified potential impact.

9. The vehicle as set forth in claim 8 wherein said position sensor is further configured to sense that the occupant is in a generally lying position and said processor is further configured to control said mechanism to reposition the occupant to a generally upright position in response to the identified potential impact.

10. The vehicle as set forth in claim 8 wherein said position sensor is further configured to sense that the occupant is facing generally away from the potential impact and said processor is further configured to control said mechanism to reposition the occupant to generally face toward the potential impact.

11. The vehicle as set forth in claim 8 wherein said processor is further configured to calculate a time to impact of the vehicle with an external object in response to the potential impact of the vehicle with the external object being identified.

12. The vehicle as set forth in claim 11 wherein said processor is further configured to calculate a time to reposition the occupant from the sensed position to the more advantageous position.

13. The vehicle as set forth in claim 12 wherein said processor is configured to control said mechanism to reposition the occupant only if the calculated time to reposition the occupant is less than the calculated time to impact.

14. The vehicle as set forth in claim 8 wherein said mechanism comprises a drive motor.

15. An occupant safety system for a vehicle, said vehicle including a seat for supporting an occupant of the vehicle and a mechanism operatively connected to the seat to change the position of the occupant between a first position and a second position, said system comprising:
an environment sensor configured to sense an environment around the vehicle;
a position sensor configured to sense the position of the occupant;
a processor in communication with said environment sensor, said position sensor, and said mechanism and configured to
identify a potential impact of the vehicle with an external object utilizing said environment sensor,
determine a position of the occupant utilizing said position sensor,
determine an advantageous position of the occupant based on the identified potential impact; and
control the mechanism to reposition the occupant to the advantageous position in response to the identified potential impact.
